(19) United States
(12) Patent Application Publication
(10) Pub. No.: US 2024/0378654 A1
(43) Pub. Date: Nov. 14, 2024

(54) MACHINE-LEARNED LARGE LANGUAGE MODEL FOR SENTIMENT ANALYSIS FOR CURATING REPLACEMENTS FOR AN ONLINE SYSTEM

(71) Applicant: Maplebear Inc., San Francisco, CA (US)

(72) Inventors: Joseph Olivier, San Bruno, CA (US); Lukasz Czekaj, North Las Vegas, NV (US); Domenico Matteo, San Mateo, CA (US); Brent Luna, Oakland, CA (US); Mark Ding, Seattle, WA (US); Mathieu Hartvick, Ottawa (CA)

(21) Appl. No.: 18/660,901

(22) Filed: May 10, 2024

Related U.S. Application Data
(60) Provisional application No. 63/465,636, filed on May 11, 2023.

(51) Int. Cl. G06Q 30/0601; G06Q 30/0282

(52) U.S. Cl. CPC G06Q 30/0629; G06Q 30/0282; G06Q 30/0631

(57) ABSTRACT

An online system determines whether to recommend a replacement item to a user based on a predicted sentiment score. The online system receives one or more comments from user feedback on the replacement items. The online system generates a prompt for each user comment for input to a machine-learned model. The online system generates a sentiment score for the ordered item and a replacement item based on the inferred sentiments by the model serving system. Using the sentiment score, the online system determines whether to recommend the replacement item.

### CROSS-REFERENCE TO RELATED APPLICATIONS

This application claims the benefit of U.S. Provisional Patent Application No. 63/465,636, filed on May 11, 2023, which is incorporated herein by reference in its entirety.

### BACKGROUND

An online system is an online platform that provides one or more online services. An example of an online service is allowing users to perform transactions associated with items. The items may represent physical entities stored in a physical location. A user can place an order for purchasing items, such as groceries, from participating retailers via the online system, with the shopping being done by a picker. After the picker finishes shopping, the order is delivered to the user's address. Oftentimes, the user's order contains an item that is not available at a grocery store or other locations where the picker is gathering the order. In such cases, the picker may need to quickly determine a replacement item for the item that is unavailable. Replacing an item in the order with a replacement item that is not satisfactory to the user may deteriorate the user's experience with the online system.

### SUMMARY

In accordance with one or more aspects of the disclosure, an online system may determine whether or not to recommend a replacement item to a customer based on a predicted sentiment score. The online system may identify one or more replacement items that were previously provided as replacement items for an ordered item, as well as user feedback for the replacement items. The online system receives one or more comments on the replacement items. The online system generates a prompt for each user comment for input to a machine-learned language model. The online system may provide the prompt to a model serving system for execution by the machine-learned language model. The online system receives a response from the model serving system that is generated by executing the machine-learned language model on the prompt. The online system generates a sentiment score for the ordered item and a replacement item based on the inferred sentiments by the model serving system. Using the sentiment score, the online system determines whether to recommend the replacement item.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIGS. 3A and 3B illustrate example processes for generating sentiments to comments using a machine-learned language model, in accordance with one or more embodiments.

FIG. 4 illustrates an example screenshot to a picker device presenting replacement items based on sentiment analysis of feedback comments submitted by users, in accordance with one or more embodiments.

FIG. 5 is a flowchart for determining whether to recommend a replacement item based on a predicted sentiment score, in accordance with one or more embodiments.

### DETAILED DESCRIPTION

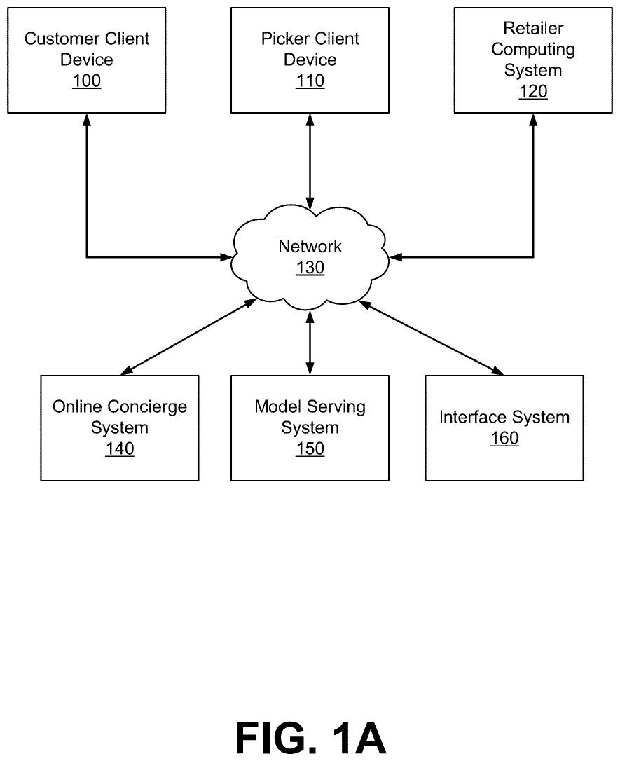

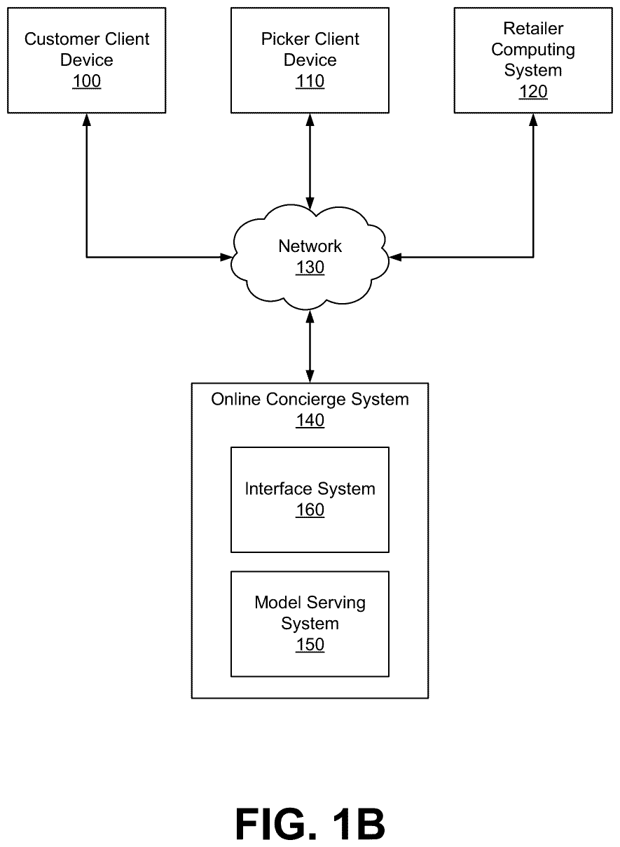

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1A, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

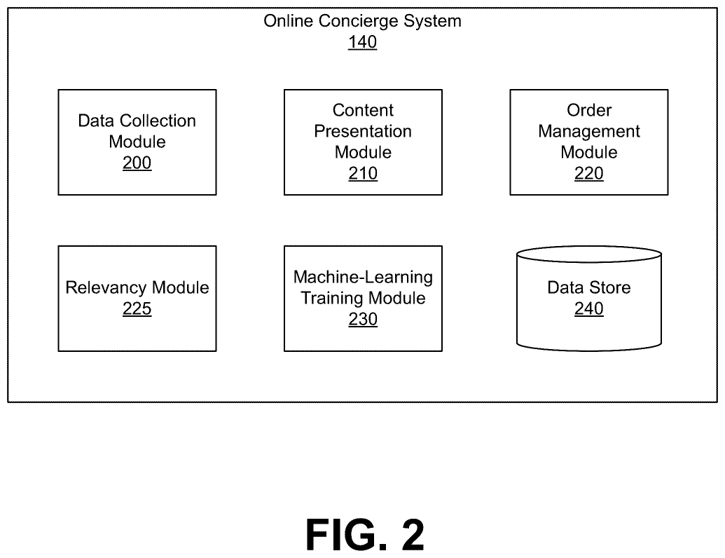

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLMs, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 performs a query to determine a set of candidate replacement items for an ordered item. For example, the ordered item may be unavailable at a retailer, and a picker may use the online system 140 to determine a viable replacement for the user. Specifically, as pickers fulfill an order with replacement items when ordered items are unavailable, the online system 140 may receive feedback from users in the form of, for example, text comments or images, and the like. In one or more embodiments, the online system 140 performs a sentiment analysis on the user feedback for replacement items for an ordered item using a machine-learned model such as an LLM or cross-modal LLM. After the sentiment analysis, the online system 140 determines one or more replacement items for an ordered item based on the sentiment analysis.

Specifically, the online system 140 obtains feedback data for an ordered item and the one or more replacement items that were each provided as a replacement item for the respective ordered item in the past. For a pair including the ordered item and a replacement item (e.g., ordered honeycrisp apples and Granny Smith apples as replacement) the online system 140 prepares a prompt for input to the model serving system 150. In some embodiments, the prompt includes a request for the LLM to assign a sentiment score to customer feedback for the replacement item. The prompt may specify an ordered item, a replacement item, and a customer's feedback in the form of a comment. The model serving system 150 generates a sentiment score for the customer's feedback. In some embodiments, the score is between −1 and +1, with score below 0 indicating a negative sentiment and a poor replacement item. A score between 0 and +1 may indicate a positive sentiment and a good replacement item.

The online system 140 receives a response to the prompt from the model serving system 150 based on execution of the machine-learned model using the prompt. The online system 140 obtains the response and assigns a sentiment score to the replacement item. In one instance, the sentiment score for a replacement item, for an ordered item, may be an average score of the sentiment scores of multiple user feedback data on the replacement item. In some embodiments, the sentiment score may be user-specific and saved for future reference for the specific customer.

In one or more embodiments, the online system 140 uses the sentiment scores for items and replacement item pairs to provide improved replacement item recommendations. Using the sentiment score for a candidate replacement item, the online system 140 may determine whether or not to recommend the candidate replacement item as the recommended replacement item. In one or more embodiments, the online system 140 accesses a relevance model configured to receive an ordered item, a replacement candidate item, and the sentiment score determined for the pair and to generate a relevancy score that indicates how well the replacement candidate item is suitable as a replacement for that ordered item.

For example, if a customer ordered organic lettuce through the online system 140, the picker may determine that non-organic lettuce is unavailable. Based on previous user feedback, the online system 140 may use the model serving system 150 to determine that previous users, on average, had relatively positive responses when they received organic lettuce as a replacement item for non-organic lettuce, resulting in a sentiment score of 0.82 for the pair. The online system 140 inputs non-organic lettuce, organic lettuce as a replacement, and the sentiment score 0.82 for input to the relevance model to generate a relevancy score for replacing non-organic lettuce with organic lettuce. The online system 140 may repeat similar processes for other replacement candidate items for the ordered item. If the relevancy score is above a threshold, the online system 140 may recommend organic lettuce as a replacement item. In contrast, if the relevancy score is equal to or less than the threshold, the online system might not recommend the organic lettuce as the replacement item.

In this manner, the online system 140 uses feedback data from users to evaluate sentiment scores and improve relevancy score predictions for replacement items. This way, items that are relevant and highly-regarded by users are recommended as replacement items, improving overall customer experience and reducing the likelihood of future negative feedback. As described in further detail below, the online system 140 may also configure an LLM-powered agent that is configured to perform one or more automated actions to update relevancy of replacement items and generate replacement item recommendations and explanations to pickers associated with the online system 140.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

In one or more embodiments, the online system 140 performs a query to predict a user sentiment towards a replacement item and target item pair. The online system 140 may retrieve previous user feedback data on replacement pairs of items. Specifically, the online system 140 provides previous user feedback in response to replacement items to the interface system 160. The online system 140 provides a query to the interface system 160. The online system 140 receives a response to the prompt from the interface system 160 based on execution of the machine-learned model in the model serving system 150 using prompts generated by the interface system 160. The online system 140 may obtain the response and determine a sentiment score for the replacement item based on the previous user feedback.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The relevancy module 225 determines suggestions for replacement items based on sentiment scores obtained for ordered items and their replacement candidate item pairs. As described in conjunction with FIG. 2, the relevancy module 225 obtains sentiment scores for an ordered item and replacement item pairs in conjunction with a machine-learned language model. In one or more embodiments, at least a component of the relevancy module 225 is configured as an LLM-powered agent that can use LLM's to reason through problems or queries, to create a plan to solve the problem, and to execute a plan with a set of tools to perform one or more actions. As discussed above in conjunction with FIG. 2, the relevancy module 225 may perform sentiment analysis on comments received from users regarding replacement items, as well as perform automated actions based on the analysis to intelligently update relevancy for replacement items, and to generate recommendations to pickers for potential replacement items as well as natural language-based explanations.

Generating Sentiment Scores from User Comments

The relevancy module 225 receives one or more comments with respect to replacing an item in an order. In one or more embodiments, the comments include user feedback comments (e.g., reviews) on the order after the order has been fulfilled, and/or transcripts between a messaging interface of the user and the picker regarding a replacement item for an item in the user's order. Using an LLM presents a technical advantage by leveraging the LLM's ability to process raw, natural text from the user with a holistic view to derive a more accurate sentiment analysis. Compared to traditional classification models that typically involve intermediate preprocessing steps such as extracting keywords, phrases, or n-grams, the LLM is trained to process nuanced contexts of particular expressions, and the like.

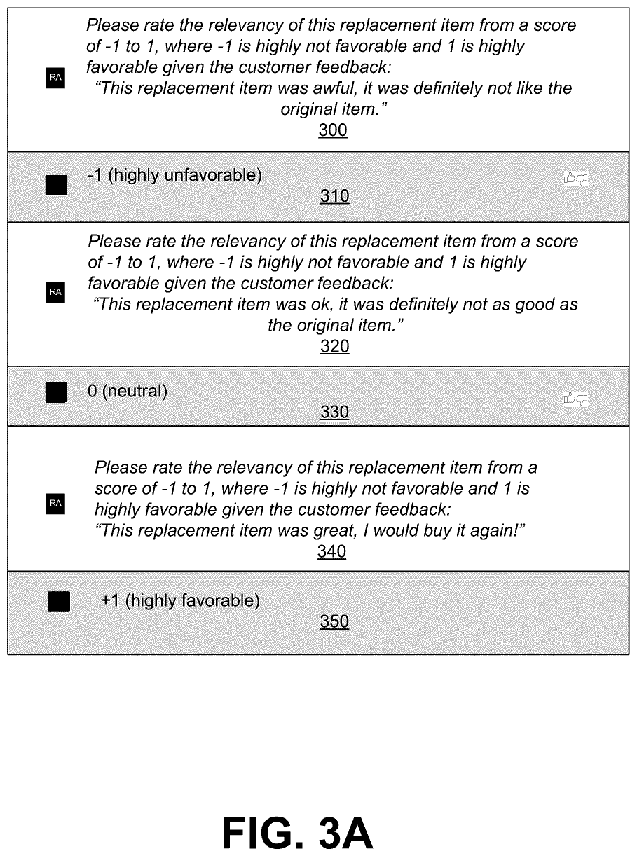

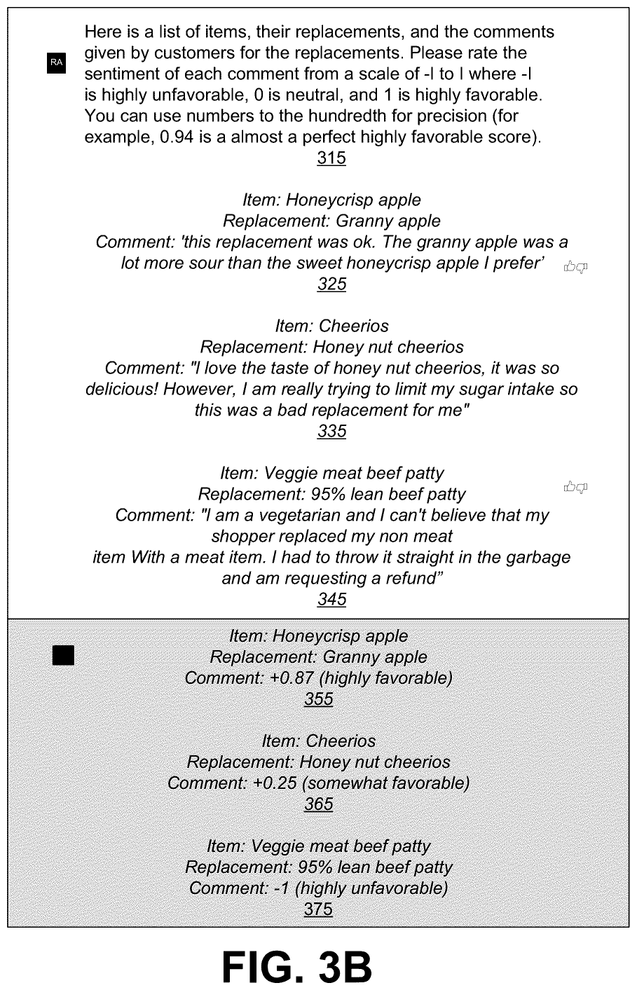

FIG. 3A is an example of providing a prompt to a LLM to evaluate user feedback on using an item for a replacement of another item. The relevancy module 225 may provide prompts requesting a relevancy of a replacement item based on user feedback. In the first example, the relevancy module 225 requests a relevancy score (sentiment score) between −1 to 1, where −1 is not favorable and 1 is highly favorable, given a particular user feedback.

A first example of customer feedback comment 300 in FIG. 3A describes the replacement item as “awful . . . definitely not like the original item.”. In this case, the model serving system 150 returns a score 310 of −1 (highly unfavorable) for the replacement item. In a second example, the relevancy module 225 requests a relevancy score with different example user feedback. The second example customer feedback 320 describes the replacement as “ok . . . wasn't as good as the original item.”. The model serving system returns a score 330 of 0, indicating a neutral sentiment or relevancy. The final example in FIG. 3A illustrates a prompt with another customer's feedback 340, indicating that the “replacement item was great, I would buy it again.” The model serving system 150 returns a score of 1, indicating a highly favorable replacement item 350.

The relevancy module 225 may average the scores from the model serving system 150 in order to assign the replacement item and ordered item pair a rounded sentiment prediction. In one or more embodiments, the relevancy module 225 may use one score based on the feedback of the customer for whom the relevancy module 225 is recommending a replacement item. For example, the relevancy module 225 may determine that a user previously provided feedback with a sentiment score of −1 for a given replacement. The relevancy module 225 may avoid that replacement based on the user's previous feedback, rather than referencing an averaged sentiment score from multiple users.

FIG. 3B illustrates an example of providing a prompt to an LLM to evaluate a sentiment of each user-provided comment, in accordance with one or more embodiments. The relevancy module 225 may provide a prompt including instructions for a request to assign a sentiment score to each comment for a set of replacements 315. In the example illustrated in FIG. 3B, the interface system 160 provides items and their replacement items, along with an associated user-provided comment.

In the first example, the item is a honey crisp apple, the replacement is a granny apple, and the comment 325 indicates that the “replacement was ok,” and elaborates on differences between the items and the user's preferences. The model serving system 150 predicts a sentiment score 355 of 0.87, indicating a highly favorable sentiment towards the replacement from the user.

In the second example, the interface system provides the item, Cheerios, and a replacement item, Honey Nut Cheerios, along with user feedback 335 indicating that the replacement “was so delicious . . . however, I am really trying to limit my sugar intake so this was a bad replacement for me.” The model serving system 150 predicts a sentiment score 365 of 0.25 for the replacement pair, indicating a somewhat favorable replacement.

In the final example, the relevancy module 225 provides the item, a vegan meat alternative, and the replacement, a lean beef patty. The user feedback 345 associated with this pair of items indicates that they “had to throw it straight in the garbage and am requesting a refund.” The model serving system 150 predicts a sentiment score 375 of −1 for this item pair, indicating a poor replacement. The relevancy module 225 may generate sentiment scores for various item and replacement item pairs, and the scores may be stored in a database.

### LLM-Powered Agent for Replacement Items

In one or more embodiments, the relevancy module 225 includes a component with LLM-powered agency, in which the agent is configured to intelligently reason through problems or requests (e.g., picker asking whether a Granny apple is a good replacement for Honeycrisp apple) to generate a response in conjunction with an LLM. Thus, responsive to receiving a request, the agent can automatically (i.e., without intermediate human intervention) perform one or more actions to incorporate sentiment scores to the process of generating recommendations for replacement items.

In one or more embodiments, one potential action is for the agent to update a relevance model with the sentiment scores generated for replacement items. In one or more embodiments, the relevancy module 225 trains a relevance model configured to receive an ordered item, a replacement candidate item, the sentiment score for the pair and to generate a relevancy score indicating how suitable the candidate item is as a replacement for the ordered item. The relevance score generated by the relevance model may incorporate various factors to determine the relevance of a replacement item for a given item. A higher relevance score may indicate a higher likelihood the user of the order will find the replacement item satisfactory. Thus, the online system 140 may generate recommendations for replacement items for a given item if the identified replacement items have a relevance score above a threshold.

Responsive to generating a sentiment score (or average sentiment score across comments from different users) for a replacement item (e.g., Granny apple for Honeycrisp apple), the agent of the relevancy module 225 may determine to provide the sentiment score as an additional feature to the relevance model. Thus, a higher sentiment score may generally result in a higher relevance score. Subsequently, the relevance score for the replacement item may be generated by applying the relevance model to the features including the sentiment score for the replacement item that was generated in conjunction with the LLM. The relevancy module 225 updates a database or cache with the sentiment score, such that the relevance model can incorporate the sentiment score when generating the relevance score for the pair of items.

In one or more embodiments, the agent may update the relevance model with sentiment scores only if the sentiment score is above a predetermined threshold (indicating significant favorability) or below a predetermined threshold (indicating significant dis-favorability). Thus, the sentiment scores only affect the relevance scores if the sentiment scores from the user comments express significant favorability or dis-favorability for a replacement item.

In one or more embodiments, one potential action is responsive to receiving a request from a picker, the agent provides a confirmation or feedback on a potential replacement item. For example, a picker through the picker client device may submit a request on whether a honey nut version of a cereal is a good replacement item for the original version of the cereal. The agent may retrieve the sentiment scores obtained from feedback comments provided by users on whether the honey nut version of the cereal is a good replacement item for the original version. The agent may retrieve the averaged sentiment scores for the pair of items (e.g., 0.92) and provide a confirmation on the display of the picker client device that the honey nut version is “a great replacement for the original version of the cereal!” based on a summary of the comments that users have submitted regarding the replacement.

In one or more embodiments, one potential action is responsive to receiving a request from a picker of multiple options for replacement items for a given item, the agent provides feedback on each option with natural language feedback based on the inferred sentiment scores or relevance scores for the replacement items.

In one or more embodiments, a potential action is to determine customized replacement items for the user based on data specific to the user. The data specific to the user may be instances of previous user order history, analysis of the previously presented replacement items, demographic data of the user, browsing history of the user, and the like.

In one or more embodiments, the agent may present customized replacement items for a user. The agent of the relevancy module 225 receives user history to determine whether to recommend the replacement item based on the received sentiment score and data specific to the user. In one or more embodiments, the agent, in conjunction with a LLM, aggregates various factors, including the sentiment score generated from user comments on the replacement item and other factors from other models and/or LLM's that include customized factors specific to the user to generate a reasoning on why the replacement item is a good or bad replacement item and/or generate alternative recommendations for the picker.

In one or more embodiments, the relevancy module 225 presents evaluations from the model serving system when recommending a replacement item for a user of the online system 140. The relevancy module 225 presents a suggestion to the shopper, in real-time, fulfilling an order with a replacement item for a missing item in the user's order.

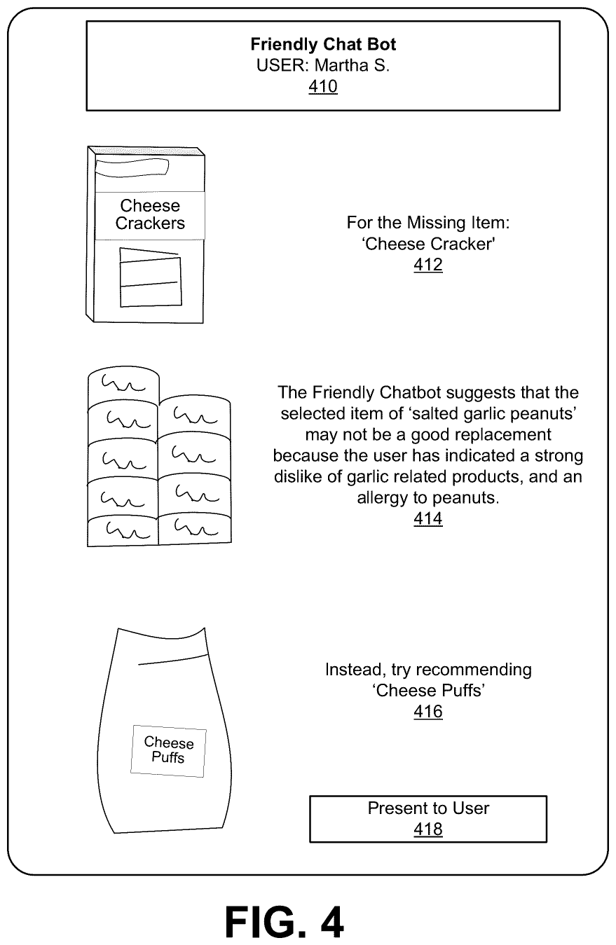

FIG. 4 is an example of an agent of the relevancy module 225 presenting evaluations of potential replacement items for a cheese crackers item 412 that was included in the user's order but was unavailable at the retailer store. A user interface (UI) 410 of a Friendly Chat Bot for User Martha S. is prompted for the picker. The relevancy module 225 presents a received evaluation for the unavailable item of cheese crackers 412.

The relevancy module 225 determines the sentiment score for one or more potential replacement items, including salted garlic peanuts and cheese puffs. For example, the sentiment score of 0.75 may be retrieved for salted garlic peanuts and the sentiment score of 0.95 may be retrieved for cheese puffs (e.g., determined based on feedback comments across users). The agent also obtains user-specific factors obtained from the previous order history of the user and aggregates the factors as well as the sentiment scores to generate feedback on the potential replacement items. Specifically, the agent by including user data determines that the selected replacement item of salted garlic peanuts is determined not to be a good replacement item for the user, as the user's order history indicates the user has indicated a strong dislike of garlic and an allergy to peanuts.

The relevancy module 225 presents the UI to the picker client device with a feedback 414: “The Friendly Chatbot suggests that the selected item of ‘salted garlic peanuts’ may not be a good replacement because the user has indicated a strong dislike of garlic related products, and an allergy to peanuts.” Further, the relevance module 225 provides real-time analysis of an alternative replacement item for the picker, and instead recommends the picker to suggest recommending the cheese puffs item 416 to the picker. FIG. 4 depicts a button 418 interface to present the recommended item to the user such that the user can approve the replacement item.

### Fine-Tuning Process for LLM

In one or more embodiments, the relevancy module 225 can further fine-tune parameters of the LLM using a training set including a set of training instances. A training instance includes user feedback data from a respective user and a known sentiment for the user feedback. In one instance, the known sentiment is one of “positive,” (assigned numerical score +1) “negative,” (assigned numerical score −1) or neutral (assigned numerical score 0). The online system 140 trains the sentiment model using the training data.

In one or more embodiments, the relevancy module 225 identifies instances of feedback in which positive feedback was received for replacement items and negative feedback was received for replacement items from users, as replacement items are recommended and fulfilled for orders. The relevancy module 225 may obtain comments including user reviews, transcripts between user and picker messages regarding replacement items and label each comment as receiving positive feedback (i.e., known sentiment score of +1), and/or label each comment as receiving negative feedback (i.e., known sentiment score of −1).

In one or more embodiments, the relevancy module 225 repeats the process of generating sentiment scores and/or relevance scores, generating replacement item recommendations based on these scores, and obtaining feedback from future orders that are fulfilled using these replacement items. Returning to the first example in FIG. 3B, the Granny apple may be fulfilled as a replacement item. The user of the order may submit a feedback comment indicating whether the replacement item was favorable or not. The comment may then be labeled with a corresponding sentiment score and included in the set of training instances.

In one or more embodiments, a training data instance may include a prompt and labels indicating a known sentiment score. For example, a prompt may include instructions (e.g., instructions 300 shown in FIG. 3A or instructions 315 shown in FIG. 3B), contents of the feedback comments, and other types of contextual information. The label is the known sentiment score value.

The relevancy module 225 encodes the data into a set of input tokens, in which a token is a numerical vector representing a word, sub-word, phrase, pixels, latent pixels, in a latent space. When the transformer architecture of the machine-learned model (e.g., LLM) is of an autoregressive architecture, the LLM may be applied to generate one or more output tokens that correspond to the positive outputs. An output token is decoded to determine a probability that the decoded token corresponds to a corresponding token in the label.

The relevancy module 225 determines a loss function across the one or more output tokens that indicates a difference (e.g., logit difference) between tokens in the label and the output tokens generated by the forward pass of the transformer model. As an example, the loss function may be an NLP loss for each token combined across one or more output tokens generated for the label. The relevancy module 225 obtains one or more error terms from the loss function and performs backpropagation to update parameters of the transformer architecture.

In one or more embodiments, the relevancy module 225 further trains the relevance model using a training set including a set of training instances. The relevance model may be configured as a machine-learned model, including but not limited to, a neural network model, a transformer architecture, and the like. A training instance for the relevance model includes an item, a replacement item for the item, the sentiment score determined for the pair, a set of features describing the item and the replacement item, and a known relevancy score that indicates whether the replacement item was a suitable replacement for the item. For example, the relevancy score may be +1 if highly relevant, and −1 if highly irrelevant. The online system 140 trains parameters of the relevance model using the training data to incorporate sentiment scores from users for a given pair of an ordered item and a replacement item.

In one or more embodiments, after updating relevancy scores, the sentiment model can be updated by future pairings of a specific replacement item. For example, if a replacement item is scored as having extremely positive relevance, then future replacements of the same item may also express that strong positivity. In one instance, repeated replacements will serve as a positive (or negative) feedback loop and can be used to increase confidence in the initial relevancy scores assigned from the sentiment analysis.

The machine learning training module 230 trains machine learning models used by the online concierge system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

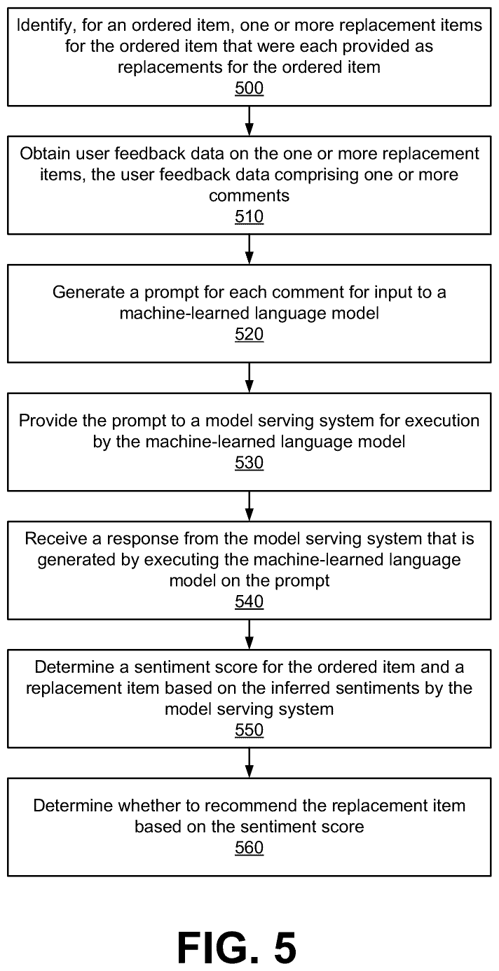

FIG. 5 is a flowchart for a method of determining whether to recommend a replacement item, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention. The online system 140 identifies 500 one or more replacement items for an ordered item. Each replacement item was previously provided as replacements for the ordered item. The online system 140 obtains 510 user feedback data on the one or more replacement items, the user feedback data comprising one or more comments. The online system generates 520 a prompt for each comment for input to a machine-learned language model. The online system 140 provides 530 the prompt to a model serving system for execution by the machine-learned language model for execution. The online system 140 receives 540 a response from the model serving system that is generated by executing the machine-learned language model on the prompt. The online system 140 determines 550 a sentiment score for the ordered item and a replacement item based on the inferred sentiments by the model serving system 150. The online system 140 determines 560 whether to recommend the replacement item based on the sentiment score. The online system 140 may recommend the replacement item if it has a sentiment score above a threshold. For example, the online system 140 may recommend the replacement item only if it has a sentiment score greater than 0 or greater than 0.5. In one or more embodiments, the online system 140 ranks the replacement items based on their sentiment scores and selects a replacement item from the highest ranked items to recommend.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
identifying, for an ordered item, one or more replacement items for the ordered item that were each provided as replacement items for the ordered item;
obtaining user feedback data on the one or more replacement items, the user feedback data comprising one or more comments in text form;
for each comment, generating a prompt for input to a machine-learned language model, the prompt specifying a request to infer a sentiment on the comment;
providing the prompt to a model serving system for execution by the machine-learned language model;
receiving, from the model serving system, a response generated by executing the machine-learned language model on the prompt;
generating sentiment scores for the ordered item and the one or more replacement items based on the inferred sentiments by the model serving system;
generating relevance scores for the one or more replacement items by applying a relevance model to features of the ordered item, the one or more replacement items, and the sentiment scores; and
providing a replacement item for display to the user based on the sentiment scores or the relevance scores for the replacement item.

2. The method of claim 1, wherein the sentiment score is encoded in a range between −1 and +1, wherein a +1 score indicates a most favorable sentiment and a −1 indicates a most negative sentiment.

3. The method of claim 1, further comprising:
identifying whether the sentiment scores for the one or more replacement items are above a first threshold or below a second threshold; and
responsive to identifying that the one or more replacement items are above the first threshold or below the second threshold, applying the relevance model to the sentiment scores to generate the relevance scores.

4. The method of claim 1, further comprising:
receiving, at a software agent, a request for feedback on one or more second replacement items for a second ordered item;
retrieving sentiment scores for the second replacement items;
generating summaries of whether the second replacement items are favorable replacements for the second ordered item; and
providing the feedback to a client device of the request.

5. The method of claim 1, further comprising:
obtaining a sentiment score for the one or more replacement items and a set of factors for the one or more replacement items describes order history of a user of the order; and
generating a set of customized replacement items for the user by combining the sentiment score and the set of factors.

6. The method of claim 5, further comprising:
receiving an indication through a user interface to present the set of customized replacement items to the user of the order.

7. The method of claim 1, wherein the machine-learned language model is a transformer architecture including one or more attention layers, wherein an attention layer is coupled to receives queries, keys, and values and a machine layer generates attention outputs.

8. A non-transitory computer readable medium having instructions encoded thereon that, when executed by a processor, cause the processor to:
identify, for an ordered item, one or more replacement items for the ordered item that were each provided as replacement items for the ordered item;
obtain user feedback data on the one or more replacement items, the user feedback data comprising one or more comments in text form;
for each comment, generate a prompt for input to a machine-learned language model, the prompt specifying a request to infer a sentiment on the comment;
provide the prompt to a model serving system for execution by the machine-learned language model;
receive, from the model serving system, a response generated by executing the machine-learned language model on the prompt;
generate sentiment scores for the ordered item and the one or more replacement items based on the inferred sentiments by the model serving system;
generate relevance scores for the one or more replacement items by applying a relevance model to features of the ordered item, the one or more replacement items, and the sentiment scores; and
provide a replacement item for display to the user based on the sentiment scores or the relevance scores for the replacement item.

9. The non-transitory computer readable medium of claim 8, wherein the sentiment score is encoded in a range between −1 and +1, wherein a +1 score indicates a most favorable sentiment and a −1 indicates a most negative sentiment.

10. The non-transitory computer readable medium of claim 8, further storing instructions that cause the processor to:
identify whether the sentiment scores for the one or more replacement items are above a first threshold or below a second threshold; and
responsive to identifying that the one or more replacement items are above the first threshold or below the second threshold, apply the relevance model to the sentiment scores to generate the relevance scores.

11. The non-transitory computer readable medium of claim 8, further storing instructions that cause the processor to:
receive, at a software agent, a request for feedback on one or more second replacement items for a second ordered item;
retrieve sentiment scores for the second replacement items;
generate summaries of whether the second replacement items are favorable replacements for the second ordered item; and
provide the feedback to a client device of the request.

12. The non-transitory computer readable medium of claim 8, further storing instructions that cause the processor to:
obtain a sentiment score for the one or more replacement items and a set of factors for the one or more replacement items that describe order history of a user of the order; and
generate a set of customized replacement items for the user by combining the sentiment score and the set of factors.

13. The non-transitory computer readable medium of claim 12, further storing instructions that cause the processor to:
receive an indication through a user interface to present the set of customized replacement items to a user of the order.

14. The non-transitory computer readable medium of claim 8, wherein the machine-learned language model is a transformer architecture including one or more attention layers, wherein an attention layer is coupled to receives queries, keys, and values and an machine layer generates attention outputs.

15. A computer system, comprising:
a processor; and
a non-transitory computer readable storage medium having instructions encoded thereon that, when executed by the processor, cause the computer system to:
identify, for an ordered item, one or more replacement items for the ordered item that were each provided as replacement items for the ordered item;
obtain user feedback data on the one or more replacement items, the user feedback data comprising one or more comments in text form;
for each comment, generate a prompt for input to a machine-learned language model, the prompt specifying a request to infer a sentiment on the comment;
provide the prompt to a model serving system for execution by the machine-learned language model;
receive, from the model serving system, a response generated by executing the machine-learned language model on the prompt;
generate sentiment scores for the ordered item and the one or more replacement items based on the inferred sentiments by the model serving system;
generate relevance scores for the one or more replacement items by applying a relevance model to features of the ordered item, the one or more replacement items, and the sentiment scores; and
provide a replacement item for display to the user based on the sentiment scores or the relevance scores for the replacement item.

16. The computer system of claim 15, wherein the sentiment score is encoded in a range between −1 and +1, wherein a +1 score indicates a most favorable sentiment and a −1 indicates a most negative sentiment.

17. The computer system of claim 15, further storing instructions that, when executed by the processor, cause the computer system to:
identify whether the sentiment scores for the one or more replacement items are above a first threshold or below a second threshold; and
responsive to identifying that the one or more replacement items are above the first threshold or below the second threshold, apply the relevance model to the sentiment scores to generate the relevance scores.

18. The computer system of claim 15, further storing instructions that, when executed by the processor, cause the computer system to:
receive, at a software agent, a request for feedback on one or more second replacement items for a second ordered item;
retrieve sentiment scores for the second replacement items;
generate summaries of whether the second replacement items are favorable replacements for the second ordered item; and
provide the feedback to a client device of the request.

19. The computer system of claim 15, further storing instructions that, when executed by the processor, cause the computer system to:
obtain a sentiment score for the one or more replacement items and a set of factors for the one or more replacement items that describe order history of a user of the order; and
generate a set of customized replacement items for the user by combining the sentiment score and the set of factors.

20. The computer system of claim 19, the instructions further comprising instructions that, when executed by the processor, cause the computer system to:
receive an indication through a user interface to present the set of customized replacement items to a user of the order.
